(19) United States
(12) Patent Application Publication
(10) Pub. No.: US 2003/0169677 A1
(43) Pub. Date: Sep. 11, 2003

(54) Optical recording medium and method of producing the same

(76) Inventors: Shinichiro Iimura, Tokyo (JP); Hiroshi Ogawa, Kanagawa (JP)

Correspondence Address: Cooper & Dunham, 1185 Avenue of the Americas, New York, NY, 10036, US

(21) Appl. No.: 10/257,705

(22) PCT Filed: Feb. 18, 2002
(86) PCT No.: PCT/JP02/01374

(30) Foreign Application Priority Data
Feb. 22, 2001 (JP) 200147302

(51) Int. Cl. G11B 7/24

(52) U.S. Cl. 369/275.4; 369/275.5

(57) ABSTRACT

The present invention is directed to an optical recording medium (1) adapted so that at least a reflection film (3), and a protective film (4) are laminated in succession on a substrate (2), and light is irradiated from the protective film (4) side so that reproduction of information signals is carried out, wherein grooves (5) or emboss pits (6) corresponding to information signals are formed along tracks at the reflection film (3).

### TECHNICAL FIELD

The present invention relates to an optical recording medium in which light is irradiated from the protective film side formed on the uppermost layer of laminated films laminated on a substrate so that recording and/or reproduction of information signals are carried out.

### BACKGROUND ART

As an optical recording medium, there are an optical disc of the ROM (Read Only Memory) type exclusive for reproduction in which emboss pits corresponding to information signals are formed in advance on a disc substrate (hereinafter referred to as ROM type disc), and an optical disc of the RAM (Random Access Memory) type in which signals are recorded at a recording film formed on a disc substrate, and reproduction, additional writing, or rewrite operation of signals, etc. can be carried out as occasion demands (hereinafter referred to as RAM type disc).

Meanwhile, in these optical discs, reproduction resolution of the optical pick-up mounted at a recording/reproducing apparatus is improved to thereby attain high recording density. In more practical sense, there is carried out a method of shortening wavelength λ of laser beams irradiated onto the optical disc, or enlarging numerical aperture NA of object lens to reduce spot diameter of laser beams irradiated onto the optical disc.

However, in the case where NA of the object lens is enlarged, it is necessary to further thin thickness of the disc substrate. This is because tolerance of angle (tilt angle) where disc surface is shifted from the perpendicularity with respect to the optical axis of the optical pick-up becomes small, and this tilt angle is easy to undergo influence of aberration or doble refraction based on thickness of the disc substrate. Namely, in the optical disc, in order to cope with realization of high NA of the object lens, it is necessary to thin thickness of the disc substrate so that the tilt angle is as small as possible.

For example, in the digital audio disc, thickness of the disc substrate is caused to be about 1.2 mm. On the contrary, in DVD (Digital Versatile Disc) having recording capacity which is 6 to 8 times greater than the digital audio disc, thickness of the disc substrate is caused to be about 0.6 mm.

However, in such optical discs, it is deemed that realization of higher recording density is required in future, and it is deemed that realization of thinner disc substrateis required.

In view of the above, as an optical recording medium which copes with realization of high recording density, there has been proposed an optical disc in which light is irradiated from the protective film side formed on the uppermost layer of laminated layers laminated on the disc substrate so that recording and/or reproduction of information signals are carried out. In this optical disc, the protective film is caused to be of the thin film configuration so that it is possible to cope with realization of higher NA of the object lens.

Meanwhile, the ROM type disc among the above-described optical discs has, as shown in FIG. 1, a structure in which a reflection film 101 and a protective film 102 are laminated in order on a disc substrate 100 where emboss pits corresponding to information signals are formed in advance.

In this ROM type disc, when laser beams L which have been converged by the object lens are irradiated from the disc substrate 100 side, reflection factor of laser beams L reflected at the reflection film 101 changes by interference of light taking place at emboss pits. Further, as the result of the fact that reflection factor change of the laser beams L is detected, reproduction of information signals is carried out.

However, in the ROM type disc, as shown in FIG. 2, when laser beams L which have been converged by the object lens are irradiated from the protective layer 102 side, reflection surface corresponding to emboss pits is formed at the reflection film 101, whereas this reflection surface has shape different from emboss pits formed at the disc substrate 100. For this reason, reflection factor change of laser beams L is lowered. Namely, since reflection surface corresponding to emboss pits is gently formed at this reflection film 101, it is impossible to clarify its edge portion, leading to lowering of reflection factor change of laser beams L when laser beams L are irradiated from the protective film 102 side.

Particularly, in the case where the film thickness of the reflection film 101 is sufficiently thicker than emboss pits formed at the disc substrate 100, it is very difficult to make a control such that shape corresponding to emboss pits of this reflection film 101 results in shape corresponding to emboss pits formed at the disc substrate 100.

For this reason, in the conventional ROM type disc, there was the problem that when laser beams L which have been converged by the object lens are irradiated from the protective film 102 side, satisfactory optical characteristic, i.e., satisfactory reproduction output cannot be obtained.

On the other hand, a writable RAM type disc has, as shown in FIG. 3, the configuration in which a recording film 201, a reflection film 202 and a protective film 203 are laminated in order on a disc substrate 200 where grooves 200a are formed along tracks. Further, in this RAM type disc, as the result of the fact that laser beams L which have been converged by the object lens are irradiated from the disc substrate 200 side onto the recording film 201 formed on the grooves 200a, recording/reproduction of information signals are carried out.

Meanwhile, in the case where laser beams L which have been converged by the object lens are irradiated from the protective film 203 side, a RAM type disc has, as shown in FIG. 4, the structure that reflection film 202, recording film 201 and protective film 203 are laminated in order on the disc substrate 200 where grooves 200a are formed along tracks.

In this case, reflection surface corresponding to grooves 200a is formed similarly to the above-described ROM type disc at the reflection film 202, whereas this reflection surface takes a shape different from the grooves 200a formed at the disc substrate 200. Namely, since reflection surface corresponding to grooves 200a is gently formed at the reflection film 202, it becomes difficult to clarify its edge portion. Accordingly, shape corresponding to grooves 200a of the recording film 201 formed on this reflection film 202 would also result in shape different from grooves 200a formed at the disc substrate 200.

Particularly, since film thickness of the recording film 201 becomes equal to about several ten to several hundred nm, shape corresponding to grooves 200a of this recording film 201 would result in shape increasingly different from grooves 200a formed at the disc substrate 200.

For this reason, in the conventional RAM type disc, there was the problem that when laser beams L which have been converged by the object lens are irradiated from the protective film 203 side to the recording film 201, satisfactory recording characteristic and/or optical characteristic, etc. cannot be obtained.

Moreover, in the RAM type disc, as shown in FIG. 5, there is a recording system which is so called land groove recording such that laser beams L which have been converged by the object lens are irradiated from the disc substrate 200 side onto the recording film 201 on grooves 200a and the recording film 201 on lands 200b formed between grooves 200a and grooves 200a, whereby recording/reproduction of information signals are carried out.

However, also in this case, as shown in FIG. 6, when laser beams L which have been converged by the object lens are irradiated from the protective film 203 side, shape corresponding to land 200b formed at the recording film 201 results in shape different from land 200b formed at the disc substrate 200. For this reason, it is very difficult to obtain satisfactory recording characteristic and/or optical characteristic, etc.

Particularly, in this case, it is important to control shapes corresponding to groove 200a and land 200b of the recording film 201 so that ratio between groove 200a and land 200b has the one-to-one correspondence relationship.

### DISCLOSURE OF THE INVENTION

The present invention has been proposed in view of such conventional circumstances, and its object is to provide a high quality optical recording medium and a method of producing the same in which, in order to cope with realization of high recording density, even in the case where light is irradiated from the protective film side, suitable recording and/or reproduction of information signals can be carried out.

To attain this object, the present invention is directed to an optical recording medium in which at least a reflection film and a protective film are laminated in order on a substrate, whereby light is irradiated from the protective film side so that reproduction of information signals is carried out, wherein emboss pits corresponding to information signals are formed along tracks at the reflection film.

As described above, in the optical recording medium according to the present invention, since emboss pits corresponding to information signals are formed along tracks at the reflection film, even in the case where light is irradiated from the protective film side, it is possible to carry out suitable reproduction of information signals.

It is to be noted that grooves serving as guide groove may be formed along tracks together with the emboss pits at this reflection film.

Moreover, the present invention is directed to an optical recording medium in which at least a reflection film, a recording film and a protective film are laminated in order on a substrate, whereby light is irradiated from the protective film side so that recording and/or reproduction of information signals are carried out, wherein grooves serving as guide groove are formed along tracks at the reflection film.

As described above, in the optical recording medium according to the present invention, since grooves serving as guide groove are formed along tracks at the reflection film, and the recording film is formed on this reflection film, even in the case where light is irradiated from the protective film side onto the recording film, it is possible to carry out suitable recording and/or reproduction of information signals.

Further, the present invention is directed to a method of producing an optical recording medium in which at least a reflection film, and a protective film are laminated in order, whereby light is irradiated from the protective film side so that reproduction of information signals is carried out, wherein in forming the reflection film, emboss pits corresponding to information signals are formed by press molding.

As described above, in the method of producing optical recording medium according to the present invention, it is possible to form emboss pits corresponding to information signals with good accuracy and easily at the reflection film. Thus, even in the case where light is irradiated from the protective film side, it is possible to easily produce an optical recording medium in which suitable reproduction of information signals can be carried out.

It is to be noted that, in forming this reflection film, grooves serving as guide groove may be formed along tracks by press molding together with emboss pits.

In addition, the present invention is directed to a method of producing an optical recording medium in which at least a reflection film, a recording film and a protective film are laminated in order on a substrate, whereby light is irradiated from the protective film side so that recording and/or reproduction of information signals are carried out, wherein in forming the reflection film, grooves serving as guide groove are formed along tracks by press molding.

As described above, in the method of producing optical recording medium according to the present invention, grooves serving as guide groove can be formed with good accuracy and easily along tracks at the reflection film, and recording film is formed thereon. Thus, even in the case where light is irradiated from the protective film side onto the recording film, it is possible to easily produce an optical recording medium in which suitable recording and/or reproduction of information signals can be carried out.

Still further objects of the present invention and more practical merits obtained by the present invention will become more apparent from the description of the embodiments which will be given below.

### BRIEF DESCRIPTION OF THE DRAWINGS

FIG. 1 is an essential part cross sectional view showing the state where laser beams are irradiated from the disc substrate side in a conventional ROM type disc.

FIG. 2 is an essential part cross sectional view showing the state where laser beams are irradiated from the protective film side in the conventional ROM type disc.

FIG. 3 is an essential part cross sectional view showing the state where laser beams are irradiated from the disc substrate side onto recording film in a conventional RAM type disc.

FIG. 4 is an essential part cross sectional view showing the state where laser beams are irradiated from the protective film side onto recording film in the conventional RAM type disc.

FIG. 5 is an essential part cross sectional view showing the state where laser beams are irradiated from the disc substrate side with respect to recording film formed on land of disc substrate in the conventional RAM type disc.

FIG. 6 is an essential part cross sectional view showing the state where laser beams are irradiated from the protective film side with respect to recording film formed on land of disc substrate in the conventional RAM type disc.

FIG. 7 is an essential part cross sectional view of a ROM type disc to which the present invention is applied.

FIG. 8 is a cross sectional perspective view showing the state where reflection film is formed on disc substrate in the ROM type disc.

FIG. 9 is a schematic perspective view showing an example of the configuration of press machine.

FIG. 10 is a schematic perspective view showing another example of the configuration of press machine.

FIG. 11 is a schematic perspective view showing a further example of the configuration of press machine.

FIG. 12 is a schematic perspective view showing a still further example of the configuration of press machine.

FIG. 13 is an essential part cross sectional view showing the state where laser beams L are irradiated from the protective film side with respect to emboss pits formed on land of reflection film in the ROM type disc.

FIG. 14 is a cross sectional perspective view showing the state where emboss pits are formed on land of reflection film in the ROM type disc.

FIG. 15 is an essential part cross sectional view of a RAM type disc to which the present invention is applied.

FIG. 16 is a cross sectional perspective view showing the state where reflection film is formed on disc substrate in the RAM type disc.

FIG. 17 is an essential part cross sectional view showing the state where laser beams L are irradiated from the protective film side with respect to recording film formed on land of reflection film in the RAM type disc.

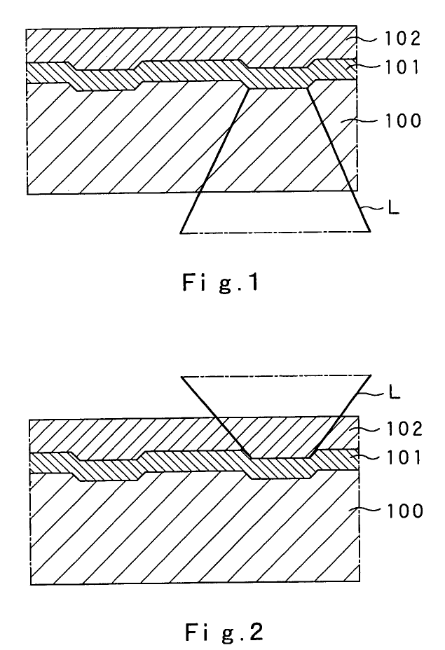

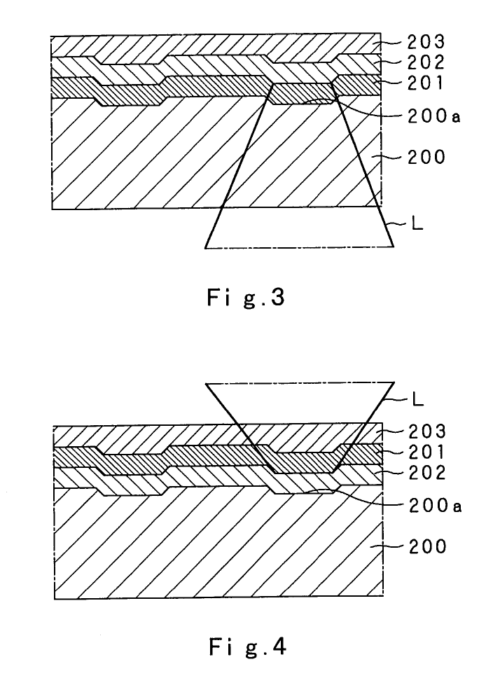

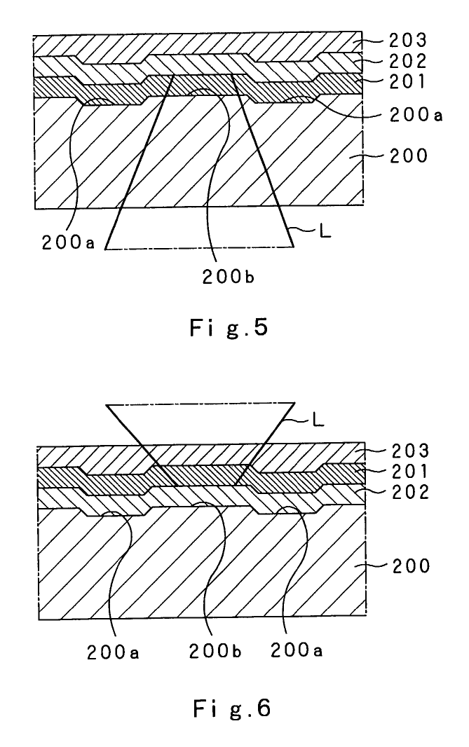

### BEST MODE FOR CARRYING OUT THE INVENTION

An optical recording medium and a method of producing the same to which the present invention is applied will now be described in more practical sense with reference to the attached drawings.

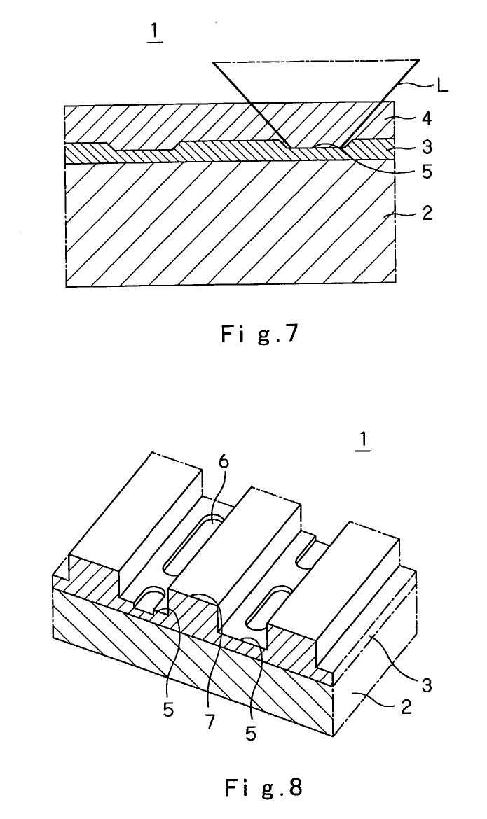

First, an optical disc of the ROM (Read Only Memory) type exclusive for reproduction (hereinafter referred to as ROM type disc) to which the present invention is applied shown in FIG. 7 will be described. In this case, FIG. 7 is an essential part cross sectional view showing the structure of this ROM type disc 1.

This ROM type disc 1 takes substantially disc shape, and has the structure in which a reflection film 3 and a protective film 4 are laminated in order on the principal surface of a disc substrate 2 where a center hole is bored at the central portion.

In this ROM type disc 1, when reproduction of information signals is carried out by an optical disc unit, laser beams L are converged by an object lens of an optical pick-up mounted at the optical disc unit, and the converged laser beams L are irradiated from the protective film 4 side. Thus, it is possible to cope with realization of higher NA of the object lens.

In this ROM type disc 1, the disc substrate 2 consists of, e.g., injection-molded plastic material such as polycarbonate (PC), polymethaciylate (PMMA), acrylic resin or epoxy resin, etc. Moreover, as material of the disc substrate 2, any material which satisfies strength and mechanical dimension may be used. For example, glass, metal or completion-molded paper, etc. may be used.

Further, this disc substrate 2 is caused to be, e.g., thickness of about 0.1 to 1.1 mm which has sufficient strength as a supporting body and is economically advantageous.

The reflection film 3 consists of, e.g., metallic material such as Al , Ag, Au, Cu, Pt, etc. or dielectric material, etc., and is formed on the disc substrate 2 by the thin-film formation technology such as deposition method or sputtering method, etc. Further, this reflection film 3 may be film in which the above-described material is formed or molded in a sheet form in advance and is stuck on the disc substrate 2 by adhesive agent, etc.

Further, this reflection film 3 is caused to be, e.g., thickness of about 0.05 to 10 μm which is economically advantageous, and sufficiently satisfies the function as the reflection film.

In addition, at this reflection film 3, as shown in FIGS. 7 and 8, grooves 5 serving as guide groove and pit train (not shown in FIG. 7) consisting of a large number of emboss pits 6 on the grooves 5 are formed spirally or concentrically at a predetermined track pitch every track. In this case, FIG. 8 is a cross sectional perspective view showing the state where the reflection film 3 is formed on the disc substrate 2.

It is to be noted that, as the grooves 5, in addition to straight grooves, there can be mentioned wobbling grooves formed so as to undergo wobbling at a predetermined period.

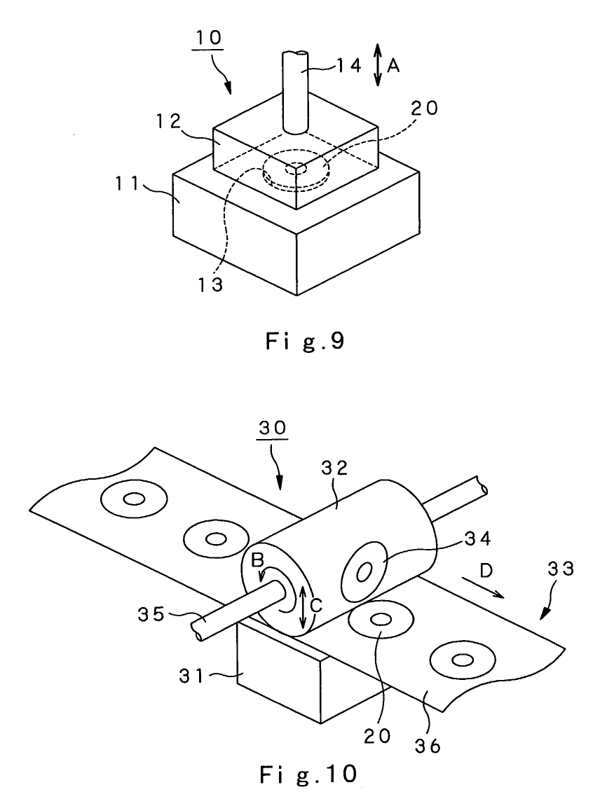

Here, in this technique, a press machine 10 as shown in FIG. 9 is used to carry out press molding with respect to the disc substrate 2 on which the reflection film 3 is formed to thereby form the grooves 5 and the emboss pits 6 at the reflection film 3. It is to be noted that, in the following description, as occasion demands, the disc substrate 2 where the reflection film 3 is formed is assumed to be collectively handled as a disc substrate 20.

This press machine 10 comprises a pedestal 11 on which the disc substrate 20 is mounted, and a metal mold 12 positioned above this pedestal 11.

The pedestal 11 is disposed in a manner opposite to the metal mold 12, and a recessed portion 13 corresponding to external shape of the disc substrate 20 is formed at the surface opposite to that metal mold 12. Further, the disc substrate 20 is fitted into this recessed portion 13 so that positioning with respect to the metal mold 12 is carried out.

On the other hand, at the surface opposite to the pedestal 11 of the metal mold 12, uneven pattern (not shown) corresponding to grooves 5 and emboss pits 6 of the reflection film 3 is formed. Moreover, the metal mold 12 is connected to hydraulic mechanism (not shown) through a spindle 14, and is permitted to be in contact with the pedestal 11 or to be away therefrom in the direction indicated by arrow A in FIG. 9 by this hydraulic mechanism.

In the press machine 10 constituted as described above, when the disc substrate 20 is mounted on the pedestal 11 in such a manner that the reflection film 3 is opposite to the metal mold 12, the metal mold 12 is lowered from the upper direction to carry out press molding at a predetermined pressure with respect to the disc substrate 20 which has been caused to undergo positioning on this pedestal 11.

Thus, it is possible to form the grooves 5 and the emboss pits 6 with good accuracy and easily with respect to the reflection film 3 formed on the disc substrate 2.

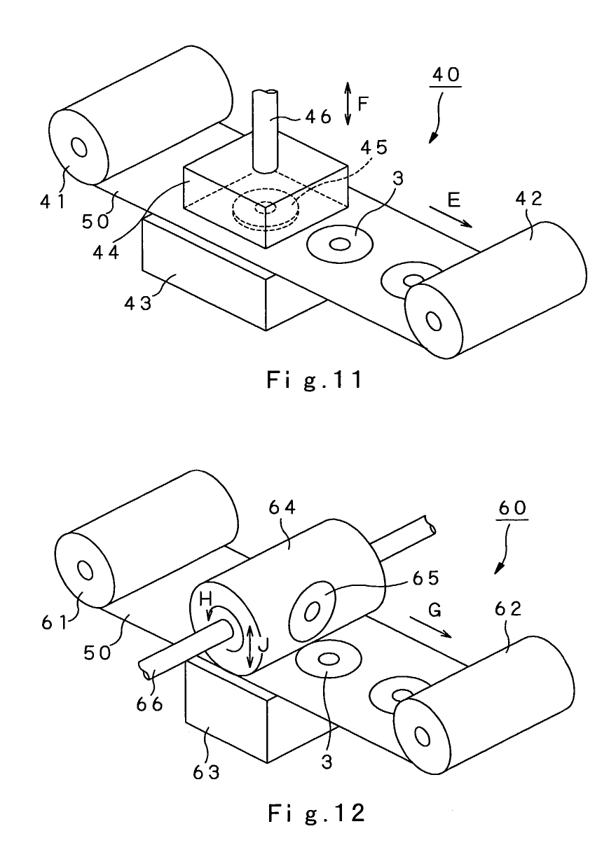

In addition, with respect to the disc substrate 20, a press machine 30 as shown in FIG. 10 is used to continuously carry out press molding, thereby making it also possible to form the grooves 5 and the emboss pits 6 at the reflection film 3.

This press machine 30 comprises a pedestal 31, a pressure application roller 32 for putting or holding the disc substrate 20 between the pressure application roller 32 and this pedestal 31, and a carrying mechanism 33 for carrying the disc substrate 20 between the pedestal 31 and the pressure application roller 32.

The pedestal 31 is disposed in a manner opposite to the pressure application roller 32, and a carrying belt 36 of carrying mechanism 33 which will be described later is travelled on the plane surface opposite to the pressure application roller 32.

The pressure application roller 32 takes substantially cylindrical shape, wherein an uneven pattern 34 corresponding to the grooves 5 and the emboss pit 6 of the reflection film 3 is formed at the peripheral surface thereof. Moreover, the pressure application roller 32 is adapted so that it can be rotated in the direction indicated by arrow B in FIG. 10 by drive motor (not shown) connected to its spindle 35. Further, the pressure application roller 32 is adapted so that it can be moved in the direction indicated by arrow C in FIG. 10 with respect to the pedestal 31 by supporting mechanism (not shown) which supports its spindle 35. Thus, it is possible to adjust application of pressure with respect to the disc substrate 20.

The carrying mechanism 33 serves to travel the elongated carrying belt 36 held or put between the pedestal 31 and the pressure application roller 32 in the direction indicated by arrow D in Fig. 10, and disc substrates 20 are mounted at predetermined intervals on this carrying belt 36.

In the press machine 30 constituted as described above, while the pedestal 31 and the pressure application roller 32 put or hold the carrying belt 36 therebetween, disc substrates 20 mounted on the carrying belt 36 are carried or transferred toward the pressure application roller 32 side by the carrying mechanism 33. At this time, the pressure application roller 32 is rotationally driven synchronously in the same direction as the travelling direction of the carrying belt 36 at the position in contact with the pedestal 31 so that the uneven pattern 34 provided at the peripheral surface thereof and disc substrates 20 mounted at predetermined intervals on the carrying belt 36 are respectively in correspondence with each other. Further, this pressure application roller 32 continuously carries out press molding at a predetermined pressure with respect to these disc substrates 20 while this pressure application roller 32 successively puts or holds disc substrates 20 between the pressure application roller 32 and the pedestal 31.

Thus, it is possible to form with good accuracy and easily the grooves 5 and the emboss pits 6 with respect to reflection films 3 formed on respective disc substrates 2. Moreover, since press molding is continuously carried out with respect to disc substrates 20, productivity can be greatly improved.

Further, in this technique, a press machine 40 as shown in FIG. 11 may be used to continuously carry out press molding with respect to sheet-shaped reflection film 3 to thereby form the grooves 5 and the emboss pits 6 at the sheet-shaped reflection film 3 to stick, by adhesive agent, etc., onto the disc substrate 2, the sheet-shaped reflection film 3 where grooves 5 and emboss pits 6 are formed.

This press machine 40 includes a pedestal 43 and a metal mold 44 positioned above this pedestal 43 at the middle portion of the travelling path for reflection film sheet 50 travelled in the direction indicated by arrow E in FIG. 11 by a feed roll 41 for delivering the elongated reflection film sheet 50 serving as the sheet-shaped reflection film 3, and a winding roll 42 for winding the press-molded reflection film sheet 50.

The pedestal 43 is disposed in a manner opposite to the metal mold 44, and the reflection film sheet 50 is travelled on the plane surface opposite to that metal mold 44.

On the other hand, at the surface opposite to the pedestal 43 of the metal mold 44, there is formed an uneven pattern 45 corresponding to grooves 5 and emboss pits 6 of the reflection film 3. Further, the metal mold 44 is connected to hydraulic mechanism (not shown) through a spindle 46, and is adapted so that it can come into contact with the pedestal 43 or become away therefrom in the direction indicated by arrow F in FIG. 11 by this hydraulic mechanism.

In the press machine 40 constituted as described above, the reflection film sheet 50 is travelled between the pedestal 43 and the metal mold 44, and the metal mold 44 is lowered from the upper direction so that this metal mold 44 puts or holds the reflection film sheet 50 between the metal mold 44 and the pedestal 43. At this time, travelling operation of the reflection film sheet 50 is once stopped, and press molding is carried out at a predetermined pressure with respect to the reflection film sheet 50 at the same time. Further, when the metal mold 44 is away from the pedestal 43, the reflection film sheet 50 begins travelling for a second time. As the result of the fact that the metal mold 44 sequentially repeats this rising and falling operation, press molding is successively carried out at predetermined intervals with respect to the reflection film sheet 50.

Thus, it is possible to form with good accuracy and easily the grooves 5 and the emboss pits 6 with respect to the sheet-shaped reflection film 3. Moreover, since press molding is continuously carried out with respect to the sheet-shaped reflection film 3, productivity can be greatly improved.

Further, a press machine 60 as shown in FIG. 12 is used to continuously carry out press molding with respect to the reflection sheet 50, thereby also making it possible to form the grooves 5 and the emboss pits 6 at the sheet-shaped reflection film 3.

This press machine 60 comprises a pedestal 63, and a pressure application roller 64 for putting or holding the reflection film sheet 50 between the pressure application roller 64 and this pedestal 63 at the intermediate portion of the travelling path for the reflection film sheet 50 travelled in the direction indicated by the arrow G in FIG. 12 by a feed roll 61 for delivering the reflection film sheet 50 and a winding roll 62 for winding the press-molded reflection film sheet 50.

The pedestal 63 is disposed in a manner opposite to the pressure application roller 64, and the reflection film sheet 50 is travelled on the plane surface opposite to the pressure application roller 64.

The pressure application roller 64 takes substantially cylindrical shape, wherein an uneven pattern 65 corresponding to grooves 5 and emboss pits 6 of the reflection film 3 is formed at the peripheral surface thereof Moreover, the pressure application roller 64 is adapted so that it can be rotated in the direction indicated by arrow H in FIG. 12 by drive motor (not shown) connected to its spindle 66. Further, the pressure application roller 64 is adapted so that it can be moved in the direction indicated by arrow J in FIG. 12 with respect to the pedestal 63 by supporting mechanism (not shown) which supports its spindle 66. Thus, it is possible to adjust application of pressure with respect to the reflection film sheet 50.

In the press machine 60 constituted as described above, the reflection film sheet 50 is travelled between the pedestal 63 and the pressure application roller 64, and the pressure application roller 64 is rotationally driven at a predetermined rotational frequency in the same direction as the travelling direction of the reflection film sheet 50. Thus, press molding is continuously carried out at predetermined intervals with respect to this reflection film sheet 50.

Thus, it is possible to form with good accuracy and easily the grooves 5 and the emboss pits 6 with respect to the sheet-shaped reflection film 3. Moreover, since press molding is continuously carried out with respect to the sheet-shaped reflection film 3, productivity can be greatly improved.

Further, in this technique, the sheet-shaped reflection film 3 is cut out along the external shape of the disc substrate 2 from the reflection film sheet 50 where the grooves 5 and the emboss pits 6 are formed at predetermined intervals to stick this sheet-shaped reflection film 3 which has been cut out onto the disc substrate 2 by adhesive agent, etc.

Thus, it is possible to form with good accuracy and easily the grooves 5 and the emboss pits 6 at the sheet-shaped reflection film 3 stuck on the disc substrate 2.

In the ROM type disc 1, the protective film 4 consists of resin material having light transmission property, etc. In more practical sense, this protective film 4 is formed by coating, e.g., ultraviolet hardening resin on the reflection film 3 by the spin-coat method to irradiate ultraviolet rays to this ultraviolet hardening resin to harden it. Moreover, this protective layer 4 may be formed or molded in advance so as to take sheet shape, and may be stuck on the reflection film 3 by adhesive agent, etc.

Further, this protective film 4 is caused to have, e.g., a thickness of about 10 to 300 μm where optically satisfactory characteristic can be obtained and which is required for mechanically protecting the recording portion.

In the ROM type disc 1 constituted as described above, when laser beams L which have been converged by the objective lens are irradiated from the protective film 4 side, reflection factor of laser beams reflected at this reflection film 3 changes by interference of light taking place at emboss pits 6 formed at the reflection film 3. Further, by detecting reflection factor change of laser beams L, reproduction of information signals is carried out.

Further, in this ROM type disc 1, tracking servo is carried out on the basis of a push-pull signal obtained from laser beams L reflected and diffracted at grooves 5 formed at the reflection film 3. Here, the push-pull signal is obtained by detecting laser beams L reflected and diffiacted at grooves 5 by two light detectors disposed symmetrically with respect to track center to take difference between outputs from those two light detectors.

Meanwhile, in this ROM type disc 1, since the above-described grooves 5 or emboss pits 6 are formed at the reflection film 3, it is possible to clarify the edge portion of grooves 5 or emboss pits 6 formed at the reflection film 3 as compared to the case where reflection film is formed on a disc substrate where grooves or emboss pits are formed as in the prior art. As a result, even in the case where laser beams L are irradiated from the protective film 4 side, it is possible to prevent that the reflection factor change of laser beams L is lowered.

Accordingly, in this ROM type disc 1, it is possible to cope with realization of high recording density. Even in the case where laser beams L are irradiated from the protective film 4 side, it is possible to obtain satisfactory optical characteristic. Thus, it is possible greatly improve qualities of reproduction signal and tracking servo signal, etc.

Further, in this ROM type disc 1, the grooves 5 or the emboss pits 6 are formed at the reflection film 3, and laser beams L are irradiated from the protective film 4 side. For this reason, the disc substrate 2 is not required to have light transmission property, and has flattened substantially disc shape where grooves or emboss pits do not exist. Accordingly, in this ROM type disc 1, metal or compression-molded paper, etc. may be used as material of the disc substrate 2. Thus, processing after use and/or recycle, etc. are facilitated.

Further, in this technique, since the above-described grooves 5 or emboss pits 6 are formed at the reflection film 3 by the press molding, it is possible to easily form grooves 5 or emboss pits 6 at this reflection film 3, and it is possible to control, with high accuracy, shape of these grooves 5 or emboss pits 6.

Accordingly, in accordance with this technique, even in the case where laser beams L are irradiated from the protective film 4 side, it is possible to produce easily and in great quantities high quality ROM type discs 1 in which suitable reproduction of information signals can be made.

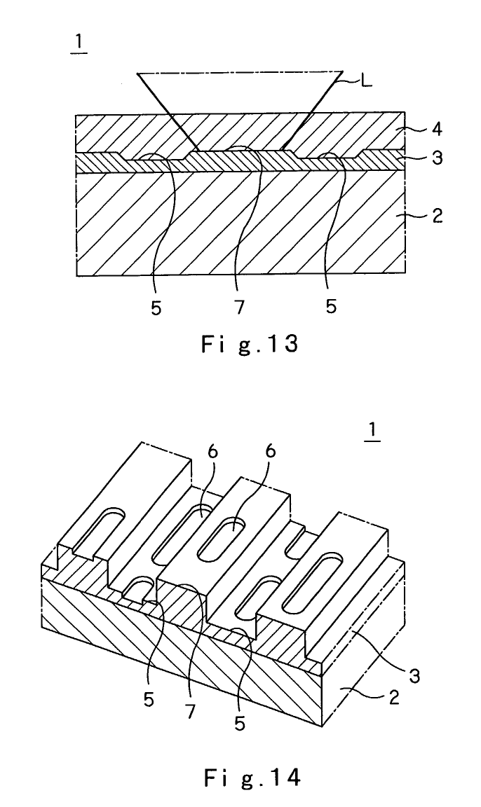

Moreover, as shown in FIGS. 13 and 14, this ROM type disc 1 may also cope with the so-called land groove recording in which pit train (not shown in FIG. 13) consisting of the above-described large number of emboss pits 6 is formed on lands 7 between grooves 5 and grooves 5 formed at the reflection film 3, whereby laser beams L are irradiated from the protective film 4 side with respect to the emboss pits 6 formed on the lands 7 so that reproduction of information signals is carried out. Further, also in this case, it is possible to control, with high accuracy, shapes of emboss pits 6, grooves 5 and lands 7 formed at the reflection film 3.

It is to be noted that the ROM type disc 1 may be also caused to be of the configuration in which only pit train consisting of the above-described emboss pits 6 is formed spirally or concentrically at a predetermined track pitch every track at the reflection film 3.

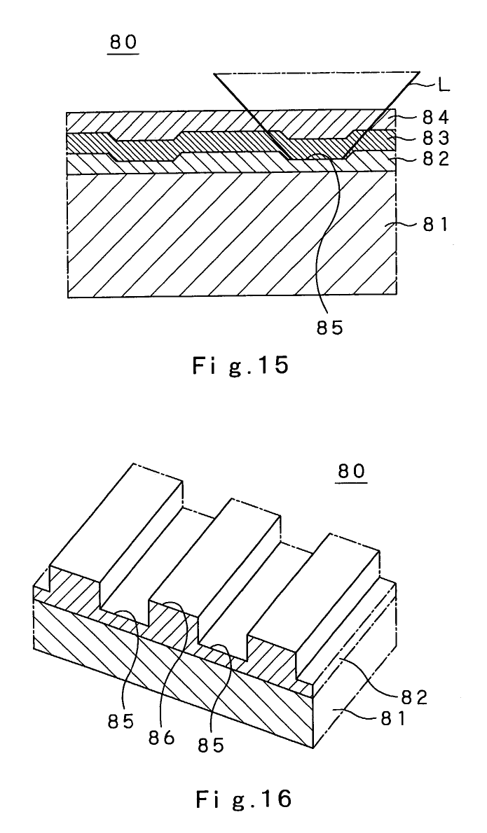

Then, a writable RAM (Random Access Memory) type optical disc (hereinafter referred to as RAM type disc) 80 to which the present invention is applied shown in FIG. 15 will be described. In this case, FIG. 15 is an essential part cross sectional view showing the structure of this RAM type disc 80.

This RAM type disc 80 takes substantially disc shape, and has the structure in which a reflection film 82, a recording film 83 and a protective film 84 are laminated in order on the principal surface of a disc substrate 81 where a center hole is bored at the central portion.

Further, in this RAM type disc 80, when recording/reproduction of information signals are carried out by the optical disc apparatus, laser beams L are converged by the object lens of the optical pick-up mounted at the optical disc apparatus, and the converged laser beams L are irradiated from the protective film 84 side. Thus, it is possible to cope with realization of high NA of the object lens.

In this RAM type disc 80, the disc substrate 81 consists of, e.g., injection-molded plastic material such as polycarbonate (PC), polymethacrylate (PMMA), aciylic resin or epoxy resin, etc. Moreover, as material of the disc substrate 81, glass, metal or compression-molded paper, etc. may be used.

Further, this disc substrate 30 is caused to have thickness of, e.g., about 0.1 to 1.1 mm which has sufficient strength as a supporting body and is economically advantageous.

The reflection film 82 consists of, e.g., metallic material such as Al, Ag, Au, Cu Pt, etc. or dielectric material, etc., and is formed on the disc substrate 81 by thin film formation technology such as deposition method or sputtering method, etc. Further, this reflection film 82 may be film formed or molded in sheet shape in advance and stuck by adhesive agent, etc. on the disc substrate 81.

Further, this reflection film 82 is caused to have thickness of, e.g., about 0.05 to 10 μm which is economically advantageous and sufficiently satisfies function as a reflection film.

In addition, at this reflection film 82, as shown in FIGS. 15 and 16, there are spirally or concentrically formed at a predetermined track pitch, every track, grooves 85 serving as guide groove. In this case, FIG. 16 is a cross sectional perspective view showing the state where the reflection film 83 is formed on the disc substrate 81.

It is to be noted that, as the groove 85, wobbling grooves formed so that they are caused to undergo wobbling at a predetermined period can be mentioned in addition to straight grooves.

Here, in this technique, the press machine 10 shown in FIG. 9 and the press machine 30 shown in FIG. 10 which have been described above are used to carry out press molding with respect to the disc substrate 81 on which the reflection film 82 is formed to thereby form the grooves 85 at the reflection film 82.

Thus, it is possible to form with good accuracy and easily the grooves 85 with respect to the reflection film 82 formed on the disc substrate 81. Further, when the press machine 30 is used to successively carry out press molding with respect to the reflection film 82 formed on the disc substrate 81, productivity can be greatly improved.

Further, in this technique, the press machine 40 shown in FIG. 11 and the press machine 60 shown in FIG. 12 which have been described above may be used to carry out press molding with respect to sheet-shaped reflection film 82 to thereby form the grooves 85 at the sheet-shaped reflection film 82 to stick the sheet-shaped reflection film 82 where the grooves 85 are formed onto the disc substrate 81 by adhesive agent, etc.

Thus, it is possible to form with good accuracy and easily the grooves 5 at the sheet-shaped reflection film 82 stuck on the disc substrate 81. In addition, when these press machines 40, 60 are used to successively carry out press molding with respect to the sheet-shaped reflection film 82, productivity can be greatly improved.

In the RAM type disc 80, in the case of, e.g., magneto-optical disc, a recording film 83 has the structure in which a transparent dielectric film consisting of SiN, etc., a magnetic recording film consisting of magnetic material such as TbFeCo, etc. and a transparent dielectric film consisting of SiN, etc. are laminated in succession by sputtering, etc. In this case, when laser beams L which have been converged by the object lens are irradiated from the protective film 84 side onto the recording film 83, external magnetic field modulated in accordance with recording information is applied to the portion locally heated to more than Curie temperature of this recording film 83 by using the magnetic head. Thus, recording or erasing of information signals is carried out, and reflection factor change of light corresponding to magnetization direction by Kerr effect is detected so that reproduction of information signals is carried out.

On the other hand, in the case of, e.g., phase change type disc, the recording film 83 has the structure in which a transparent dielectric film consisting of ZnS—SiO₂, etc., a phase change recording film consisting of phase change material such as GeSbTe, etc. and a transparent dielectric film consisting of ZnS—SiO₂, etc. are laminated in succession by sputtering, etc. In this case, by producing phase change from crystalline state to amorphous state while irradiating laser beams L which have been converged by the object lens from the protective film 84 side to the recording film 83, recording or erasing of information is carried out. By detecting reflection factor change of light followed thereby, reproduction of information is carried out.

It is to be noted that the dielectric film aims at preventing oxidation of magnetic recording film or phase change recording film, and realizing enhance effect of magneto-optical signal by multiple interference.

On the other hand, in the case of, e.g., write-once type disc, the recording film 83 is adapted so that organic coloring matter film such as cyanine system or phthalocyanine system, etc. is formed by sputtering or spin-coat, etc. In this case, recording mark is formed at the position where laser beams L are irradiated by recording power with respect to this recording film 83 while irradiating laser beams L which have been converged by the object lens from the protective film 84 side onto the recording film 83, whereby recording of information signals is carried out. By detecting reflection factor change of return light corresponding to presence or absence of recording mark while irradiating laser beams L by reproduction power with respect to the recording film 83 where this recording mark is formed, reproduction of information signals is carried out.

The protective film 84 consists of resin material having light transmission property, etc. In more practical sense, this protective film 84 is formed by coating, e.g., ultraviolet hardening resin onto the reflection film 82 by spin-coat method to irradiate ultraviolet rays onto this ultraviolet hardening resin to harden it. Further, this protective film 84 may be adapted so that it is formed or molded in advance in sheet shape, and is stuck on the recording film 83 by adhesive agent, etc.

In addition, this protective film 84 is caused to have thickness of, e.g., about 10 to 300 μm at which optically satisfactory characteristic can be obtained, and which is required for mechanically protecting the recording portion.

In the RAM type disc 80 constituted as described above, laser beams L which have been converged by the object lens are irradiated onto the recording film 83 formed on grooves 5 from the disc substrate 81 side, whereby recording/reproduction of information signals corresponding to the above-described recording film 83 are carried out.

Further, in the RAM type disc 80, tracking servo is carried out on the basis of a push-pull signal obtained from laser beams L reflected and diffracted at grooves 85 formed at the reflection film 82.

Meanwhile, in this RAM type disc 80, since the above-described grooves 85 are formed at the reflection film 82, it is possible to clarify edge portion of the grooves 85 formed at the reflection film 82 as compared to the case where reflection film or recording film is laminated on the disc substrate where grooves are formed as in the prior art. Further, also with respect to shape corresponding to the grooves 85 of the recording film 83 formed on this reflection film 82, its edge portion becomes clear. Thus, even in the case where laser beams L are irradiated from the protective film 84 side onto the recording film 83, it is possible to prevent that the reflection factor change of laser beams L is lowered.

Accordingly, in this RAM type disc 80, it is possible to cope with realization of high recording density. Even in the case where laser beams L are irradiated from the protective film 84 side, it is possible to obtain satisfactory recording characteristic or optical characteristic, etc. Thus, qualities of reproduction signal and tracking servo signal, etc. can be greatly improved.

Moreover, in this RAM type disc 80, since the grooves 85 are formed at the reflection film 82 and laser beams L are irradiated from the protective film 84 side, the disc substrate 81 is not required to have light transmission property, and has flattened substantially disc shape where there is no groove. Accordingly, in this RAM type disc 80, metal or compression-molded paper, etc. may be used as material of the disc substrate 81, and processing after use and/or recycle, etc. are facilitated.

Further, in this technique, since the above-described grooves 85 are formed at the reflection film 82 by press molding, it is possible to easily form grooves 85 at this reflection film 82, and it is possible to control shape of the grooves 85 with high accuracy.

Accordingly, in accordance with this technique, even in the case where laser beams L are irradiated from the protective film 84 side, it is possible to produce easily and in large quantities high quality RAM type discs 80 which can carry out suitable recording/reproduction of information signals.

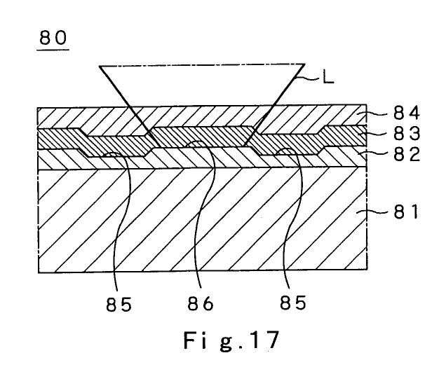

Further, as shown in FIG. 17, this RAM type disc 80 can also cope with the so-called land groove recording in which laser beams L are irradiated from the protective film 84 side with respect to recording film 83 on land 86 formed between groove 85 and groove 85 formed at the reflection film 82 so that recording/reproduction of information signals are carried out. In addition, also in this case, it is possible to control, with high accuracy, shapes of grooves 85 and lands 86 formed at the reflection film 82.

Industrial Applicability

As described above, in accordance with the optical recording medium according to the present invention, even in the case where light is irradiated from the protective film side, it is possible to carry out suitable recording and/or reproduction of information signals. Thus, it is possible to cope with realization of high recording density.

In addition, in accordance with the method of producing optical recording medium according to the present invention, even in the case where light is irradiated from the protective film side, it is possible to produce easily and in large quantities high quality optical recording media which can carry out suitable reproduction of information signals.

1. An optical recording medium in which at least a reflection film and a protective film are laminated in succession on a substrate, and light is irradiated from the protective film side so that reproduction of information signals is carried out,
wherein emboss pits corresponding to the information signals are formed along tracks at the reflection film.

2. The optical recording medium as set forth in claim 1, wherein the emboss pits are formed as the result of the fact that the reflection film is press-molded.

3. The optical recording medium as set forth in claim 1, wherein grooves serving as guide groove are formed along tracks at the reflection film.

4. The optical recording medium as set forth in claim 3, wherein the grooves are formed as the result of the fact that the reflection film is press-molded.

5. The optical recording medium as set forth in claim 1, wherein the substrate consists of plastic material, metal or paper.

6. The optical recording medium as set forth in claim 1, wherein thickness of the substrate is 0.1 to 1.1 mm.

7. The optical recording medium as set forth in claim 1, wherein thickness of the reflection film is 0.05 to 10 μm.

8. The optical recording medium as set forth in claim 1, wherein thickness of the protective film is 10 to 300 μm.

9. An optical recording medium adapted so that at least a reflection film, a recording film and a protective film are laminated in succession on a substrate, and light is irradiated from the protective film side so that recording and/or reproduction of information signals are carried out,
wherein grooves serving as guide groove are formed along tracks at the reflection film.

10. The optical recording medium as set forth in claim 9, wherein the grooves are formed as the result of the fact that the reflection film is press-molded.

11. The optical recording medium as set forth in claim 9, wherein the substrate consists of plastic material, metal or paper.

12. The optical recording medium as set forth in claim 9, wherein thickness of the substrate is 0.1 to 1.1 mm.

13. The optical recording medium as set forth in claim 9, wherein thickness of the reflection film is 0.05 to 10 μm.

14. The optical recording medium as set forth in claim 9, wherein thickness of the protective film is 10 to 300 μm.

15. A method of producing an optical recording medium adapted so that at least a reflection film, and a protective film are laminated in succession on a substrate, and light is irradiated from the protective film side so that reproduction of information signals is carried out,
wherein in forming the reflection film, emboss pits corresponding to the information signals are formed by press molding.

16. The method of producing optical recording medium as set forth in claim 15, wherein a reflection film is formed on the substrate to carry out press molding with respect to the substrate on which the reflection film is formed to thereby form the emboss pits at the reflection film.

17. The method of producing optical recording medium as set forth in claim 15, wherein press molding is carried out with respect to a sheet-shaped reflection film to thereby form the emboss pits at the sheet-shaped reflection film to stick the sheet-shaped reflection film where the emboss pits are formed onto the substrate.

18. The method of producing optical recording medium as set forth in claim 15, wherein in forming the reflection film, grooves serving as guide groove are formed along tracks by press molding.

19. The method of producing optical recording medium as set forth in claim 18, wherein a reflection film is formed on the substrate to carry out press molding with respect to the substrate on which the reflection film is formed to thereby form the grooves at the reflection film.

20. The method of producing optical recording medium as set forth in claim 18, wherein press molding is carried out with respect to a sheet-shaped reflection film to thereby form the grooves at the sheet-shaped reflection film to stick the sheet-shaped reflection film where the grooves are formed onto the substrate.

21. The method of producing optical recording medium as set forth in claim 15, wherein plastic material, metal or paper is used as material of the substrate.

22. The method of producing optical recording medium as set forth in claim 15, wherein thickness of the substrate is caused to be 0.1 to 1.1 mm.

23. The method of producing optical recording medium as set forth in claim 15, wherein thickness of the reflection film is caused to be 0.05 to 10 μm.

24. The method of producing optical recording medium as set forth in claim 15, wherein thickness of the protective film is caused to be 10 to 300 μm.

25. A method of producing an optical recording medium adapted so that at least a reflection film, a recording film and a protective film are laminated in succession on a substrate, and light is irradiated from the protective film side so that recording and/or reproduction of information signals are carried out,
wherein in forming the reflection film, grooves serving as guide groove are formed along tracks by press molding.

26. The method of producing optical recording medium as set forth in claim 25, wherein a reflection film is formed on the substrate to carry out press molding with respect to the substrate on which the reflection film is formed to thereby form the grooves at the reflection film.

27. The method of producing optical recording medium as set forth in claim 25, wherein press molding is carried out with respect to a sheet-shaped reflection film to thereby form the grooves at the sheet-shaped reflection film to stick the sheet-shaped reflection film where the grooves are formed onto the substrate.

28. The method of producing optical recording medium as set forth in claim 25, wherein plastic material, metal or paper is used as material of the substrate.

29. The method of producing optical recording medium as set forth in claim 25, wherein thickness of the substrate is caused to be 0.1 to 1.1 mm.

30. The method of producing optical recording medium as set forth in claim 25, wherein thickness of the reflection film is caused to be 0.05 to 10 μm.

31. The method of producing optical recording medium as set forth in claim 25, wherein thickness of the protective film is caused to be 10 to 300 μm.
